(19) United States
(12) Patent Application Publication
(10) Pub. No.: US 2022/0080409 A1
(43) Pub. Date: Mar. 17, 2022

(54) APPARATUS AND METHOD FOR SORTING CELLS IN A BIOLOGICAL SAMPLE

(71) Applicant: TECHNION RESEARCH & DEVELOPMENT FOUNDATION LIMITED, Haifa, IL (US)

(72) Inventors: Gilad YOSSIFON, Mazkeret-Batya (IL); Sholom SHUCHAT, Haifa (IL)

(21) Appl. No.: 17/420,078

(22) PCT Filed: Dec. 31, 2019
(86) PCT No.: PCT/IL2019/051447

§ 371 Date: Jun. 30, 2021

Related U.S. Application Data
(60) Provisional application No. 62/786,580, filed on Dec. 31, 2018.

(51) Int. Cl. B01L 3/00

(52) U.S. Cl. CPC B01L 3/50273; B01L 3/502715; B01L 2400/0424; B01L 2300/0864; B01L 2300/0645; B01L 3/502753

(57) ABSTRACT

Apparatus (20) for use with a biological sample, including at least one viable sperm cell (12) having a tail (8) and a head (6), comprising: a fluid chamber (40) shaped and sized for receiving the biological sample, and at least one electrode (80) coupled to the chamber and in operable communication with an electric source for applying alternating current (AC) to drive the at least one electrode (80) to generate a dielectrophoresis (DEP) force in the chamber. In response to the DEP force: (i) the tail of the at least one viable sperm cell is attracted to the electrode and pulled into proximity to the electrode, and simultaneously (ii) the head is repelled and distanced from the electrode such that a proximity of the tail to an edge of the electrode is greater than a proximity of the head to the edge of the electrode. Other applications are also described.

### FIELD OF THE INVENTION

Applications of the present invention relate generally to apparatus and method for sorting biological components of heterogeneous samples, and more particularly to devices and methods for sorting a semen sample.

### CROSS REFERENCE TO RELATED APPLICATIONS

This application claims the benefit of priority under 35 USC § 119(e) of U.S. Provisional Patent Application No. 62/786,580 filed Dec. 31, 2018 the contents of which are incorporated herein by reference in their entirety.

### BACKGROUND

Male infertility is a contributing factor in many cases of infertility experienced by couples. Oftentimes, the infertility is due to a low sperm count and it is often necessary to concentrate the sperm for intrauterine insemination or in vitro fertilization. In some cases, in semen samples with minute amounts of sperm, even a single spermatozoon required to fertilize an oocyte cannot be found in the ejaculate, in particular in cases in which sperm is searched for manually under a microscope.

Dielectrophoresis (DEP) is an induced motion of a particle that is caused by a non-uniform electric field acting on the dipole it induces in the particle. The particles are either attracted (positive DEP (pDEP)) to high field gradients or repelled (negative DEP (nDEP)) from them. Dielectrophoretic forces generally do not depend on a polarity of the electric field. Therefore, motion of the particle in response to dielectrophoretic forces does not result from a polarity of the particles but rather from a magnitude of the electric field. Generally, most cells and particles exhibit either pDEP or nDEP at a given frequency.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with some applications of the present invention, apparatus and methods for sorting cells and particles in a biological sample. More specifically, the apparatus and method are provided for selectively isolating and concentrating sperm cells from a biological sample (e.g., an ejaculate and/or a sperm sample removed from testis of a subject). In particular, the methods and apparatus described herein provide isolating viable sperm cells from the sample in a safe manner that maintains the sperm undamaged and in viable condition suitable for fertilization of an oocyte. Typically, applications of the present invention provide methods and apparatus for trapping the sperm cell by a tail of the sperm while at the same time distancing a head of the sperm from electric fields used to trap the tail.

For some applications, the method and apparatus are provided for manipulating at least one sperm cell in a biological sample using dielectrophoresis (DEP) while preventing potential damage to portions of the sperm cell due to high electric fields caused by the dielectrophoresis (DEP). For some applications, the method includes subjecting a biological sample including at least one sperm cell to a dielectrophoresis (DEP) force by providing alternating current (AC) field frequencies to drive at least one electrode that is in contact with the biological sample, and simultaneously eliciting both a positive and a negative DEP response in different portions of the sperm cell such that a first portion of the sperm cell is attracted to the electrode and a second portion of the sperm cell is repelled and distanced from the electrode.

More specifically, the method includes simultaneously eliciting a positive DEP response in the tail of the sperm and a negative DEP response in the head of the sperm thereby using the attraction of the tail to trap the sperm cell by the electrode while at the same time distancing the head of the sperm (which contains the DNA required for healthy reproduction) from the electric fields, thus protecting the DNA from potential damage.

In accordance with some applications of the present invention, the differential response of the head and tail to the DEP is accomplished by using a frequency that is above a crossover frequency (COF) of the tail and below a COF of the head, a crossover frequency being a frequency at which transition occurs between a negative DEP response and a positive DEP response.

The inventors have identified that, while most cells and particles exhibit either pDEP or nDEP at a given frequency, in the case of spermatozoa, the tail and the head exhibit independent behavior. It was identified by the inventors that surprisingly, the head and the tail of the sperm have unique crossover frequencies corresponding to the transition of the DEP force from repulsive (negative) to attractive (positive). It was identified by the inventors that the tail switches from a negative DEP response to a positive DEP response at lower frequencies than the head.

Thus, in accordance with some applications of the present invention, the method includes identifying and selecting a range of frequencies in which the head undergoes nDEP while the tail undergoes pDEP. As mentioned hereinabove, the head of the sperm contains the DNA that is integral for fertilization of the oocyte, whereas the tail is thought to be mostly necessary to bring the sperm to the egg and has less implications on fertilization. Therefore, applications of the present invention provide applying frequencies that elicit a negative response from the head and a positive response from the tail, and sorting and analyzing the sperm cell while simultaneously distancing the head from potentially damaging effects induced by high electric fields (e.g., Joule heating, electroporation, transmembrane induced potentials).

In accordance with some applications of the present invention, apparatus is provided for sorting sperm cells from a biological sample using dielectrophoresis (DEP). Typically, the apparatus comprises a fluid chamber shaped and size for receiving the biological sample which includes at least one viable sperm cell, and at least one electrode in communication with the chamber. An electric source applies an alternating current (AC) to the at least one electrode to generate a dielectrophoresis (DEP) force in the chamber, such that in response to the DEP force the at least one viable sperm cell is typically aligned perpendicular to a longitudinal axis of the electrode such that the tail is brought into proximity to the electrode and simultaneously the head is distanced from the electrode, thereby protecting the head from potentially damaging effects induced by the electric fields in the electrode. Additionally, or alternatively, the apparatus facilitates sorting of the at least one viable sperm cell by separating the at least one sperm cell from other components in the biological sample (for example cells that are not sperm cells, cellular particles, dead sperm cells and any other type of debris present in the sample).

There is therefore provided in accordance with some applications of the present invention, apparatus for use with a biological sample, including at least one viable sperm cell having a tail and a head, the apparatus including: a fluid chamber shaped and sized for receiving the biological sample; at least one electrode coupled to the chamber and in operable communication with an electric source configured to apply alternating current (AC) field frequencies to drive the at least one electrode to generate a dielectrophoresis (DEP) force in the chamber; and in response to the DEP force: (i) the tail of the at least one viable sperm cell is attracted to the electrode and brought into proximity to the electrode, and simultaneously (ii) the head is repelled and distanced from the electrode such that a proximity of the tail to an edge of the electrode is greater than a proximity of the head to the edge of the electrode.

For some applications, the at least one electrode is configured to generate the DEP by operating at a frequency in which the tail exhibits a positive DEP response and the head exhibits a negative DEP response.

For some applications, at least one electrode is configured to generate the DEP by operating at a frequency that is above a crossover frequency (COF) of the tail and below a COF of the head, a crossover frequency being a frequency at which transition occurs between a negative DEP response and a positive DEP response.

For some applications, the at least one electrode is configured to operate at a frequency of 10 kHz-100 MHz.

For some applications, the fluid chamber includes a sorting medium having a conductivity of 5-500 mS/m.

For some applications, the fluid chamber includes a sorting medium having a conductivity of 200-350 mS/m.

For some applications, the sorting medium has a minimum conductivity of 30 mS/m.

For some applications, the sorting medium has a minimum conductivity of 100-200 mS/m.

For some applications, the at least one electrode is configured to generate the DEP by operating at a frequency of 50 KHz-40 MHz when the fluid has a conductivity of 200-350 mS/m.

For some applications, the at least one electrode includes a pair of sorting electrodes.

For some applications, the pair of sorting electrodes has an intra-electrode distance of 1-50 microns.

For some applications, each of the electrodes are shaped to define a curved electrode.

For some applications, the at least one electrode includes a sorting electrode, and the apparatus further includes at least one focusing electrode upstream from the sorting electrode and configured to operate at a frequency in which the head, the tail and other components in the biological sample exhibit a negative DEP response, to guide the biological sample towards the sorting electrode by repelling the biological sample from the focusing electrode.

For some applications, the at least one focusing electrode is configured to operate below a crossover frequency (COF) of the head, the tail and other components in the biological sample.

For some applications, the fluid chamber includes a sorting medium having a conductivity of 5-500 mS/m, and the fluid chamber further includes a high conductivity medium having a conductivity of 800-1600 mS/m, upstream from the sorting electrodes, and the at least one focusing electrode is configured operate in the high conductivity medium to guide the biological sample towards the sorting medium.

For some applications, the at least one focusing electrode includes a first focusing electrode and the apparatus further includes a second focusing electrode downstream from the sorting electrodes and the fluid chamber further includes a high conductivity medium having a conductivity of 800-1600 mS/m, downstream from the sorting electrodes, and the second focusing electrode is configured to guide the at least one viable sperm cell from the sorting electrode to the high conductivity medium downstream from the sorting electrodes.

For some applications, the at least one focusing electrode includes a pair of focusing electrodes.

For some applications, the fluid chamber is shaped to define (i) a main flow channel in communication with the at least one electrode, (ii) a debris outlet channel downstream from the at least one electrode, and (iii) a sperm outlet channel downstream from the at least one electrode, and in response to the DEP force the at least one viable sperm cell is guided into the sperm outlet channel and the components in the biological sample that are not the at least one viable sperm cell are guide into the debris outlet channel.

For some applications, the apparatus includes a flow inducer configured to induce flow of the biological sample in the fluid chamber past the at least one electrode.

For some applications, components of the biological sample that are not the at least one viable sperm cell include components selected from the group consisting of: non-viable sperm cells and cells or particles that are not sperm cells.

For some applications, the viable sperm cell includes a sperm cell selected from the group consisting of: a live motile sperm cell, a live immotile sperm cell, an immature germ cell.

For some applications, the at least one electrode is fixed to the chamber.

For some applications, in response to the DEP force some or all of components in the biological sample that are not the at least one viable sperm cell is repelled and distanced from the at least one electrode.

For some applications, in response to the DEP force the at least one sperm cell is aligned perpendicular to a longitudinal axis of the electrode such that the tail is brought into proximity to the electrode and simultaneously the head is distanced from the electrode.

For some applications, the electric source includes a function generator.

There is further provided in accordance with some applications of the present invention, apparatus for use with a biological sample, the biological sample including at least one viable sperm cell having a tail and a head, the apparatus including: a main flow channel (i) shaped to define an inlet for introducing the biological sample into the main flow channel and (ii) shaped and sized for flow of the biological sample through the main flow channel; a pair of sorting electrodes electrically coupled to the main flow channel downstream from the inlet; a sperm outlet channel downstream from the pair of sorting electrodes; a debris outlet channel downstream from the pair of sorting electrodes; the pair of sorting electrodes are in operable communication with an electric source configured to apply alternating current (AC) field frequencies by driving the pair of sorting electrodes to generate a dielectrophoresis (DEP) force in the main flow channel, such that in response to the DEP force: (a) components in the biological sample that are not the at least one viable sperm cell are repelled from the pair of sorting electrodes and guided into the debris outlet channel; (b) the tail is attracted to and brought into proximity with the pair of sorting electrodes, and simultaneously, the head is repelled and distanced from electrodes, and (c) the viable sperm cell is guided into the sperm outlet channel.

For some applications, the pair of sorting electrodes is configured to generate the DEP by operating at a frequency in which the tail exhibits a positive DEP response and the head exhibits a negative DEP response.

For some applications, the pair of sorting electrodes is configured to generate the DEP by operating at a frequency that is above a crossover frequency (COF) of the tail and below a COF of the head, a crossover frequency being a frequency at which transition occurs between a negative DEP response and a positive DEP response.

For some applications, the pair of sorting electrodes are configured to operate at a frequency of 10 kHz-100 MHz.

For some applications, the main flow channel includes a sorting medium having a conductivity of 5-500 mS/m.

For some applications, the sorting medium has a minimum conductivity of 30 mS/m.

For some applications, the sorting medium has a minimum conductivity of 100-200 mS/m.

For some applications, the pair of sorting electrodes is configured to generate the DEP by operating at a frequency of 50 KHz-40 MHz when the fluid has a conductivity of 200-350 mS/m.

For some applications, the pair of sorting electrodes has an intra-electrode distance of 1-50 microns.

For some applications, each of the electrodes are shaped to define a curved electrode.

For some applications, the apparatus further includes at least one focusing electrode upstream from the sorting electrodes and configured to operate at a frequency in which the head, the tail and other components in the biological sample exhibit a negative DEP response, to guide the biological sample towards the sorting electrode by repelling the biological sample from the focusing electrode.

For some applications, the at least one focusing electrode is configured to operate below a crossover frequency (COF) of the head, the tail and other components in the biological sample.

For some applications, the main flow channel includes a sorting medium having a conductivity of 5-500 mS/m, and the main flow channel further includes a high conductivity medium having a conductivity of 800-1600 mS/m, upstream from the sorting electrodes, and the at least one focusing electrode is configured operate in the high conductivity medium to guide the biological sample towards the sorting medium.

For some applications, the at least one focusing electrode includes a first focusing electrode and the apparatus further includes a second focusing electrode downstream from the sorting electrodes and, the main flow channel further includes a high conductivity medium having a conductivity of 800-1600 mS/m, downstream from the sorting electrodes, and the second focusing electrode is configured to guide the at least one viable sperm cell from the sorting electrode to the high conductivity medium downstream from the sorting electrodes.

For some applications, the at least one focusing electrode includes a pair of focusing electrodes.

For some applications, further includes a flow inducer configured to induce flow of the biological sample in the fluid chamber past the at least one electrode.

For some applications, components of the biological sample that are not the at least one viable sperm cell include components selected from the group consisting of: non-viable sperm cells and cells or particles that are not sperm cells.

For some applications, the viable sperm cell includes a sperm cell selected from the group consisting of: a live motile sperm cell, a live immotile sperm cell, and an immature germ cell.

For some applications, the pair of sorting electrodes is fixed to the chamber.

For some applications, in response to the DEP force some or all of components in the biological sample that are not the at least one viable sperm cell are repelled and distanced from the pair of sorting electrodes.

For some applications, in response to the DEP force the at least one sperm cell is aligned perpendicular to a longitudinal axis of the electrode such that the tail is brought into proximity to the electrode and simultaneously the head is distanced from the electrode.

For some applications, the electric source includes a function generator.

There is further provided in accordance with some applications of the present invention, a method including using a biological sample including at least one viable sperm cell having a tail and a head; subjecting the biological sample to a dielectrophoresis (DEP) force by applying alternating current (AC) field frequencies to the biological sample by driving at least one electrode; in response to the dielectrophoresis (DEP) force, simultaneously eliciting a positive DEP response in the tail and a negative DEP response in the head thereby preventing damage to the head by orienting the sperm such that a proximity of the tail to an edge of the electrode is greater than a proximity of the head to the edge of the electrode; and isolating the sperm cell from the biological sample.

For some applications, orienting the sperm includes aligning the sperm perpendicular to a longitudinal axis of the electrode.

For some applications, the at least one electrode is configured to generate the DEP by operating at a frequency that is above a crossover frequency (COF) of the tail and below a COF of the head, a crossover frequency being a frequency at which transition occurs between a negative DEP response and a positive DEP response.

For some applications, subjecting the biological sample to the dielectrophoresis (DEP) force includes operating the electrode at a frequency of 10 kHz-100 MHz.

For some applications, the method further includes identifying a frequency range of alternating current (AC) configured for simultaneously eliciting the positive and negative response and applying the AC at the identified frequency.

For some applications, using a biological sample includes using the biological sample suspended in a fluid having a conductivity of 5-500 mS/m.

For some applications, the method further includes eliciting a negative DEP response in components of the biological sample that are not the at least one viable sperm cell thereby distancing the components from the electrode.

For some applications, the method further includes inducing a flow of the at least one sperm cell along the longitudinal axis of the electrode while the sperm is aligned perpendicular to the longitudinal axis of the electrode and perpendicular to a direction of the flow.

For some applications, inducing the flow includes flowing the biological sample at a speed of 5-75 μm/s.

For some applications, inducing the flow includes flowing the biological sample at a speed of 25-30 μm/s.

For some applications, the method further includes actively guiding the flow of the biological sample towards the electrode.

For some applications, the at least one electrode includes a sorting electrode and wherein the method further includes guiding the biological sample towards the sorting electrode using a focusing electrode operating at a frequency that elicits a negative DEP response from the head and tail and the other components in the sample.

For some applications, the method includes collecting the at least one viable sperm cell subsequently to the isolating.

For some applications, aligning the sperm includes aligning the sperm such that a distance of the head from the electrode is at least 2-50 microns.

There is yet further provided in accordance with some applications of the present invention, a method for manipulating a viable sperm cell having a tail and a head, the method including:

subjecting the sperm cell to a dielectrophoresis (DEP) force by applying electric fields at a frequency to simultaneously elicit a positive DEP response in the tail and a negative DEP response in the head; and

attracting the tail to the electric field and distancing the head from the electric field, thereby preventing damage to the head by the electric fields.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIGS. 1A-C are images of a quadrupolar electrode setup used for determining a crossover frequency (COF) of a sperm cell, in accordance with some applications of the present invention;

FIGS. 2A-C are an image (2A) and schematic model of sperm cells (2B-C), derived in accordance with applications of the present invention;

FIGS. 3A-C are graphs depicting the measured and theoretically fitted COF results for both the head and tail, in accordance with some applications of the present invention;

FIGS. 4A-F are images of apparatus comprising a sorting chip for trapping and isolating sperm cells from other debris in a mixture, in accordance with some applications of the present invention;

FIG. 5A is a schematic illustration of the apparatus for manipulating a sperm cell, in in accordance with some applications of the present invention; and

FIG. 5B is cross section of an apparatus for manipulating a sperm cell, in accordance with some applications of the present invention.

### DETAILED DESCRIPTION

Some aspects of the present invention provide a dielectrophoresis (DEP) apparatus and isolation methods which provide for the manipulation of particles or cells and selection based on characteristics correlated with a response of particles or cells to the DEP.

Some aspects of the present invention provide an a safe, automated, high-throughput apparatus and method for processing semen samples especially those containing only rare spermatozoa and sorting the sperm cells while maintaining viability of the cells. The rare spermatozoa may be sorted and isolated from ejaculated semen or samples extracted from the testis, via a biopsy or surgery. The sperm cells obtained using the apparatus and methods of the present invention can then be used to fertilize eggs using Intracytoplasmic sperm injection ICSI.

In some aspects of the present invention, the sperm's head, which contains the DNA, is distanced from potentially damaging high electric fields using negative DEP while simultaneously manipulating and trapping the sperm using the positive DEP response of the tail.

Some aspects of the present invention include inducing a positive DEP response in the tail of the sperm simultaneously to inducing a negative DEP response in the head of the sperm. In some aspects, this is accomplished in accordance with some aspects of the present invention, by generating the DEP at a frequency that is above a crossover frequency (COF) of the tail and below a COF of the head, a crossover frequency being a frequency at which transition occurs between a negative DEP response and a positive DEP response.

In some aspects, the selected frequency is in a range of 10 kHz-100 MHz.

Some aspects of the present invention include adjusting and providing a medium having a conductivity suitable for simultaneously inducing the differential DEP response in the tail and the head of the sperm (a positive DEP response in the tail of the sperm and a negative DEP response in the head), at a given frequency. For some aspects, the conductivity of the medium in which the cells are disposed and in which the DEP is generated is 5-500 mS/m.

In accordance with some aspects of the present invention, parameters that are used for sperm cell manipulation using DEF (and eliciting positive DEP response in the tail of the sperm and a negative DEP response in the head) comprise using frequencies below 300 KHz at a medium conductivity of 33 mS/m.

In accordance with some aspects of the present invention, parameters that are used for sperm cell manipulation using DEF (and eliciting positive DEP response in the tail of the sperm and a negative DEP response in the head) comprise using frequencies below 800 KHz at a medium conductivity of 97 mS/m.

In accordance with some aspects of the present invention, parameters that are used for sperm cell manipulation using DEF (and eliciting positive DEP response in the tail of the sperm and a negative DEP response in the head) comprise using frequencies in the range of 50 KHz to 2100 KHz, at a medium conductivity of 146 mS/m.

In accordance with some aspects of the present invention, parameters that are used for sperm cell manipulation using DEF (and eliciting positive DEP response in the tail of the sperm and a negative DEP response in the head) comprise using frequencies in the range of 50 KHz to 20,000 KHz, at a medium conductivity of 200 mS/m.

In accordance with some aspects of the present invention, parameters that are used for sperm cell manipulation using DEF (and eliciting positive DEP response in the tail of the sperm and a negative DEP response in the head) comprise using frequencies in the range of 800 KHz to 21,000 KHz, at a medium conductivity of 235 mS/m.

In accordance with some aspects of the present invention, parameters that are used for sperm cell manipulation using DEF (and eliciting positive DEP response in the tail of the sperm and a negative DEP response in the head) comprise using frequencies in the range of 900 KHz to 40,000 KHz, at a medium conductivity of 270 mS/m.

In accordance with some aspects of the present invention, parameters that are used for sperm cell manipulation using DEF (and eliciting positive DEP response in the tail of the sperm and a negative DEP response in the head) comprise using frequencies above 4000 KHz at a medium conductivity of 340 mS/m.

In accordance with some aspects of the present invention at least one electrode is configured to generate the DEP by operating at a frequency of 50 KHz-40 MHz when the fluid has a conductivity of 200-350 mS/m.

Some aspects of the present invention allow for use of higher conductivity solutions that are more physiological than those conventionally used in DEP, due to low crossover frequency of the tail.

Some aspects of the present invention provide differentiating between viable and non-viable immotile sperm, with live immotile sperm exhibiting a pDEP response, and dead sperm exhibiting nDEP.

Some aspects of the present invention provide isolating viable sperm (e.g., sperm with reproductive potential) from debris in a biological sample (ejaculated semen or samples extracted from the testis). Typically, viable sperm includes a live motile sperm cell, and/or a live immotile sperm cell. Additionally, or alternatively, debris in the biological sample include all or some components including non-viable sperm cells, dead sperm cells, and cells or particles that are not sperm cells.

Some aspects of the present invention provide isolating immature sperm cells (e.g., immature sperm cells with or without a tail structure from ejaculated semen or samples extracted from the testis) based on COF traits of the sperm.

In some aspects apparatus is provided for manipulating and sorting sperm cells is provided. Typically, the apparatus comprises a fluid chamber shaped and sized for receiving a biological sample including at least one viable sperm cell having a tail and a head or an immature germ cell at an earlier stage of development, retrieved from the ejaculate or the testis. The apparatus typically includes at least one electrode (e.g., a pair of sorting electrodes) in in operable communication with an electric source configured to apply alternating current (AC) field frequencies to drive the at least one electrode to generate a dielectrophoresis (DEP) force in the chamber. The apparatus is configured in response to the DEP force to manipulate the sperm cells in the chamber such that the tail of each viable sperm cell is attracted to the electrode and brought into proximity to the electrode (exhibiting a positive DEP response), and simultaneously, the head is repelled and distanced from the electrode (exhibiting a negative DEP response) such that a proximity of the tail to an edge of the electrode is greater than a proximity of the head to the edge of the electrode.

In some aspects, the fluid chamber is shaped to define a main flow channel shaped to define an inlet for introducing the biological sample into the main flow channel and shaped and sized for flow of the biological sample therethrough. The at least one electrode (e.g., the pair of sorting electrodes) is disposed in the main flow channel downstream from the inlet. The fluid chamber is further shaped to define a a sperm outlet channel downstream from the pair of sorting electrodes and a debris outlet channel downstream from the pair of sorting electrodes. In response to the DEP force generated in the main channel by the sorting electrodes, some or all of components in the biological sample that are not viable sperm cells are repelled from the pair of sorting electrodes and guided into the debris outlet channel. In contrast, the viable sperm cells are concentrated in a vicinity of the electrode in a manner that the tail is attracted to and brought into proximity with the pair of sorting electrodes, and simultaneously, the head is repelled and distanced from electrodes. The sperm typically does not remain trapped to the electrode but rather is guided into the sperm outlet channel.

In some aspects, the apparatus is configured such that a combination of background flow and pDEP continuously guides the desired particles, e.g. sperm, to the sperm channel outlet using a combination of hydrodynamic (background flow) and pDEP forces. This is in contrast to conventional pDEP where the cells remain trapped on the electrodes until the field is turned off. A potential advantage is further protecting the sperm from the electrode by reducing exposure time of the sperm to the electrode.

In some aspects, the apparatus further comprises at least one focusing electrode (e.g., a pair of focusing electrodes) disposed upstream from the sorting electrodes and configured to operate at a frequency range that is below a crossover frequency of the biological sample (i.e., below the COF of the head and tail of sperm cells, as well as other components in the sample), thereby not attracting the sample (and in some aspects, repelling the sample) in order to guide the sample towards the sorting electrodes.

In some aspects, the apparatus is configured provide a low conductive medium suitable for sorting of the sperm cells in vicinity of the sorting electrodes while providing higher conductivity medium (resembling a physiological fluid) at other regions of the apparatus (e.g., upstream and/or downstream from the sorting electrode). Thereby, reducing the time of exposure of the sperm cells to conditions of that are more remote from physiological conditions.

In some aspects, the focusing electrode is configured to operate in medium having a relatively high conductivity medium of ˜800-1600 mS/m (resembling a physiological buffer), and may be disposed either upstream, downstream or both upstream and downstream from the sorting electrode. In this manner the biological sample is guided from the focusing electrode to the sorting electrode (the sorting electrode operating within a lower conductivity medium of 5-500 mS/m) and from the sorting electrode back to a higher conductivity medium. It is noted that in some aspects all the sample may be guided by the focusing electrode or alternatively only some of the sample may be guided by the focusing electrode. Additionally, or alternatively, focusing may be done in stages and using mediums of intermediate conductivity.

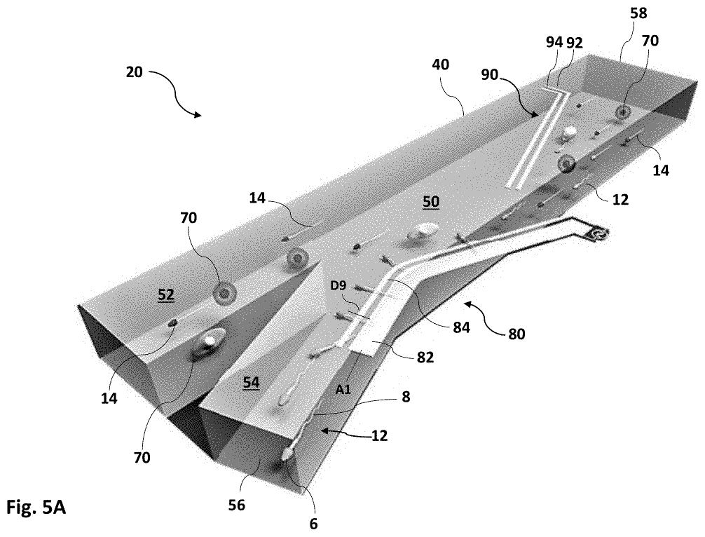

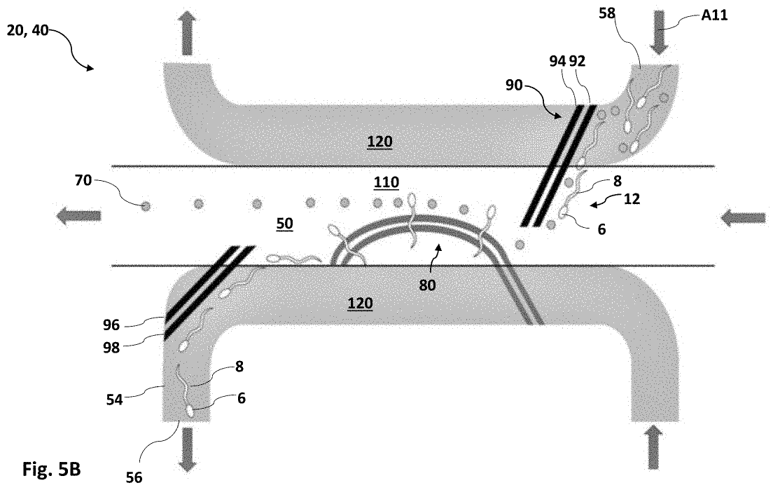

Description of the drawings begins with an overview of the apparatus as illustrated in FIGS. 5A-B.

Reference is first made to FIG. 5A, which is a schematic illustration of apparatus 20 for manipulating and sorting sperm cells in accordance with some applications of the present invention. Typically, apparatus 20 comprises a sorting chip comprising a fluid chamber 40 shaped to define a main flow channel 50 having an inlet 58 for introducing a biological sample into main flow channel 50, and shaped and sized for flow of the biological sample through main flow channel 50. Fluid chamber 40 comprises at least one sorting electrode 80 (or as shown a pair of sorting electrodes 82 and 84) electrically coupled to (e.g., embedded in) main flow channel 50, downstream from inlet 58. Fluid chamber 40 is further shaped to define a sperm outlet channel 54 downstream from the pair of sorting electrodes 82 and 84, and a debris outlet channel 52 downstream from sorting electrodes 82 and 84. For some applications, sorting electrodes 82 and 84 are shaped to define curved electrodes 82 and 84. For some applications, sorting electrodes 82 and 84 have an intra-electrode distance of 1-50 microns.

Typically, the pair of sorting electrodes are in operable communication with an electric source configured to apply to sorting electrodes 82 and 84 alternating current (AC) field frequencies that drive sorting electrodes 82 and 84, to generate a dielectrophoresis (DEP) force in the main flow channel, such that in response to the DEP force tail 8 of viable sperm cells 12 present in the biological sample exhibit a positive DEP response while head 6 of viable sperm cell 12 exhibits a negative DEP response. Thus, apparatus 20 is configured, in response to generating a DEP force in main channel 50, to attract tail 8 to the electrode thereby brining the tail (and consequently sperm cell 12) in proximity to the sorting electrodes, and simultaneously repelling and distancing head 6 from the electrode. Typically, a proximity of tail 8 to an edge of electrodes 82 and 84 is greater than a proximity of head 6 to an edge of electrodes 82 and 84. For some applications a distance D9 of head 6 from the edge of each one of electrodes 82 and 84 is at least 2-50 microns.

As shown in FIG. 5A, for some applications, viable sperm cell 12 is aligned perpendicular to a longitudinal axis A1 of electrodes 82 and 84 by attracting tail 8 and distancing head 6.

For some applications viable sperm cell 12 is guided (e.g., by flow) downstream towards channel 54. Typically, apparatus 20 is configured to use positive DEP to continuously guide particles (e.g., viable sperm cell 12) rather than trapping them until they are released. This allows for uninterrupted sorting, improving efficiency and throughput. It also reduces the amount of time that the cells are exposed to the electric fields as they follow the electrodes for only a short distance before being released and do not remain trapped on the electrode.

Alternatively, for some applications, the sperm can remain trapped to the electrode and later released.

Typically, debris components 70 that are not viable sperm cell 12, are not attracted to sporting electrodes 82 and 84 (e.g., repelled from the electrodes) and guided into debris outlet channel 52. Typically, viable sperm cell 12 includes a live motile sperm cell, and/or a live immotile sperm cell (or any mature or immature sperm cell with the potential of fertilizing an oocyte). Additionally, or alternatively, debris in the biological sample include all or some components 70 including non-viable sperm cells, dead sperm cells, and cells or particles that are not sperm cells.

For some applications, apparatus 20 further comprises at least one focusing electrode 90 (e.g., a pair of focusing electrodes 92 and 94) disposed upstream from the sorting electrodes and configured to operate at a frequency range that is below a crossover frequency of the biological sample (i.e., below the COF of head 6 and tail 8 sperm cells 12, as well as other components 70 in the sample), thereby not attracting the sample (and in some aspects, repelling the sample) in order to guide the sample towards sorting electrodes 82 and 84.

For some applications, apparatus 20 comprises a second focusing electrode (e.g., a second pair of focusing electrodes) disposed downstream from the sorting electrodes and configured to guide the sorted sperm cells from sorting electrodes 82 and 84 to sperm outlet channel 54. Second focusing electrodes are shown in FIG. 5B as electrodes 96 and 98 disposed downstream from the sorting electrodes 82 and 84. In general, focusing electrode 92, 94, 96 and 98 contribute to inducing flow and directing the biological sample in the fluid chamber. Reference is now made FIG. 5B which is a schematic illustration of apparatus 20 in accordance with some applications of the present invention. For some applications, multiple (e.g., at least two) streams of medium fluid having different conductivities flow through fluid chamber 40 allowing both (i) sorting of the sperm cells at a low conductivity of the medium (e.g., 5-500 mS/m) optimal for generation of the DEP at frequencies that elicit the nDEP response in the head and the pDEP response in the tail, and (ii) reducing time of exposure to the low conductivity medium by providing areas and streams of fluid having a relatively higher conductivity and closer to a physiological buffer (e.g., ˜800-1600 mS/m).

Generally, DEP is generated in a buffer with a lower conductivity than standard physiological buffers. For some applications, apparatus 20 implements a buffer exchange to reduce exposure time of the sperm to a non-physiological buffer.

As indicted by arrow A11, a biological sample including viable sperm 12 enters chamber 40 in a stream 120 of physiological or close to physiological buffer (˜800-1600 mS/m) along with the other cell types and debris components 70 in the sample. Focusing electrode 90 operating at a frequency below the crossover frequency (COF) of both the head and tail directs the biological sample (including all of the sperm cells as well as other cells and particles) from the high conductivity stream 120 (physiological buffer) to a DEP buffer (5-500 mS/m) in the vicinity of sorting electrode 80 (sorting medium indicated by area 110). The sorting electrode operates at a frequency above the crossover of the tail but below that of the head (and other cells in the biological sample). Sorting electrode 80 sorts out the viable sperm bringing the sperm to the bottom of the DEP buffer stream 110, while directing components 70 (other cell types and particles) to the middle/top of the DEP buffer stream 110. Downstream focusing electrode 96 and 98 operating at a frequency below that of the head and tail direct the sorted sperm to a physiological buffer stream 120 and to sperm channel outlet 56, where the sperm is collected.

It is note that additional electrode arrays and/or channels may be added in series to facilitate sorting in parallel to increase throughput (for some applications additional channels may start and end at the same point).

Additionally, or alternatively, apparatus 20 may be configured for facilitating pre-sorting steps, for example, removing large skin cells that may block the apparatus 20. For some applications, there may also be post processing steps to concentrate the sorted cells or sort them based on additional parameters.

Reference is again made to FIGS. 5A-B. Table A below is table showing non-limiting examples of crossover frequencies for the head and tail of sperm cell 12 and corresponding buffer conductivity parameters, used in accordance with some applications of the present invention.

| Buffer Conductivity | COF Tail | COF Head |
|---|---|---|
| (mS/m) | (KHz) | (KHz) |
| 33 | | 300 |
| 97 | | 800 |
| 146 | 50 | 2100 |
| 200 | 50 | 20000 |
| 235 | 800 | 21000 |
| 270 | 900 | 40000 |
| 340 | 4000 | |

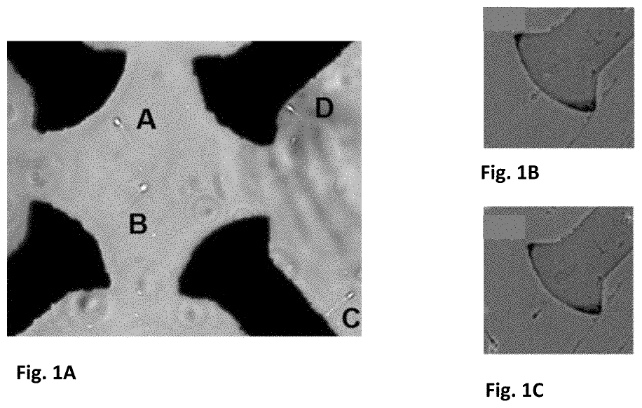

Reference is now made to FIGS. 1A-4F which relate to experimental results obtained using the apparatus and methods in accordance with applications of the present invention and described in Examples 1-5. The following description begins with setting forth the material and methods used in some applications of the present invention.

Materials and Methods Used in Some Applications of the Present Invention

A series of protocols are described hereinbelow which may be used separately or in combination, as appropriate, in accordance with applications of the present invention. It is to be appreciated that numerical values are provided by way of illustration and not limitation. Typically, but not necessarily, each value shown is an example selected from a range of values that is within 20% of the value shown. Similarly, although certain steps are described with a high level of specificity, a person of ordinary skill in the art will appreciate that other steps may be performed, mutatis mutandis.

In accordance with some applications of the present invention, the following methods were applied:

Sperm Cell Preparation

Frozen human sperm samples were thawed, pipetted into aliquots of 200 μl and diluted 200 μl:1800 μl in Quinn's Sperm Washing Medium (Sage, Trumbull Conn.). The samples were then centrifuged at 300 g for 10 minutes and the supernatant discarded. To allow for differentiation of live and dead cells, the pellet was re-suspended in 1 ml of media, and 8 μl of propidium iodide (PI) solution (concentration 1 mg/ml) was added. The samples were then incubated for 10 minutes at 37° C. and centrifuged once more for 10 minutes at 300 g's and the supernatant discarded. The resulting pellet was re-suspended in a volume of media equal to the original volume of the sample (200 μl) (depending on the concentration of sperm, it was sometimes diluted further with media). Centrifugation was necessary to remove the chemical agents used to freeze sperm. The double centrifugation also ensured uniformity in the sample's conductivity as the conductivity of semen varies between individuals.

To minimize negative effects on the cells due to the low-conductivity solution required for DEP, an isotonic solution consisting of DI water with 99.18 g/l sucrose and 2.38 g/l HEPES, was used. Although such conditions have been shown to enable most sperm cells to stay viable without DNA damage a significant decrease was still observed in their swimming velocity and motility, particularly in the lower range of conductivities tested, hence, they are still not as optimal as desired. To create solutions with different conductivities, immediately prior to the experiments, various quantities of the sperm/media solution were diluted in 400 μl of isotonic solution.

Device Fabrication

A quadrupolar electrode array was fabricated onto an indium tin oxide (ITO)-coated glass slide (Delta Technologies). Prior to patterning the transparent ITO electrodes, metal of Cr/Au (20/200 nm thickness) was deposited onto the ITO surface and patterned for the electrode pads by standard wet-etching process. Afterwards, the ITO was patterned using standard photolithography and wet-etching processes. A polydimethylsiloxane (PDMS)-based microchannel (20 μm in height and 1 mm in width) was fabricated by soft-lithography and standard photolithography. The polydimethylsiloxane (PDMS; Sylgard 184 silicone elastomer kit, Dow corning) was cast onto an SU-8 (SU8 2025, Microchem) structure formed by soft-lithography and cured at 75° C. for 2 hours in the oven. After curing, the PDMS was peeled off from the SU-8 mold and the inlets of the microchannel were punched out using a biopsy punch. The PDMS microchannel and the glass slide containing the electrode array were aligned and reversibly bonded by manually pressing them together.

To reduce, at least partly, sticking of the sperm cells to the electrodes and channel walls, the channels and slides were coated with Sigmacote (Sigma Aldrich). The chips were then heated on a hotplate for an hour according to the manufacturer's instructions.

Experimental Set-Up

Various AC field frequencies with a sinusoidal waveform were applied using a function generator (33250A, Agilent). An AC field with an amplitude of 16-20Vpp was applied while the sperm cells response was recorded using an Andor Neo sCMOS camera attached to a Nikon TI inverted epi-fluorescent microscope with a 10× objective lens.

Fitting

To fit a model to the obtained data, a code was written in Matlab that computes the CM and does a parametric sweep of the dielectric properties of the sperm, using the ranges found in literature for other cell types as a starting point. For each solution conductivity, the resulting error between the crossover frequency as predicted by the model (i.e. the frequency at which the theoretical CM is equal to zero) and the experimentally observed crossover frequency was calculated. In calculating the error, any model point within the crossover region was considered as having zero error. For points outside the region, the difference between the model and the boundary of the region was defined as the error with the center of the crossover region used to normalize the error to a percentage. The overall error of each of the models was then calculated using the root mean squared error.

Experimental Data

The experiments described hereinbelow were performed by the inventors in accordance with applications of the present invention and using the techniques described hereinabove.

### Example 1: Experimental Methodology

Reference is now made to FIGS. 1A-C which are images of a quadrupolar electrode setup used for determining a crossover frequency (COF) of a sperm cell, in accordance with some applications of the present invention.

The DEP response of the head and tail of human sperm was tested at various frequencies using the quadrupolar electrode setup (FIG. 1A). As the head and tail are part of a single body, only the total resultant velocity of the body can be measured, and it is not possible to decouple the independent forces acting on the head and tail. Therefore, regular methods used in other DEP studies were not used in this study, where the DEP force and electrorotation (ROT) velocity is measured. Instead the focus was on measuring the crossover frequencies (COF) of the head and tail in solutions of various conductivities.

Using a pressure gradient, the sperm cells were flowed across the electrodes at speeds between 25 to 35 μm/s. Videos were taken at numerous frequencies and were later analyzed to observe if the head and/or tail was repelled or attracted by the electrodes. Negative DEP behaviors, such as the head or tail being repelled upwards and out of focus or being diverted horizontally out of its streamline, could be observed by focusing the image on the horizontal plane closest to the electrodes. The converse was observed for pDEP (FIGS. 1A-C). The flow was necessary, as otherwise, it was not possible to observe the specific response of the head or tail, rather, depending on the frequency, only the response of the dominant one would be observed. Inducing a flow causes both the head and tail to pass by the electrode, making it possible to individually observe their behavior.

By definition, near the crossover frequency region, the DEP response is very weak. Additionally, due to inherent biological variability and the variability in the direction of the DEP force relative to the background flow, the DEP response cannot be definitively categorized as positive or negative. Therefore, the experiments aimed to find a region within which the COF is situated. At frequencies away from the COF, the effect of the background flow was negligible as a consistent DEP response was obtained regardless of whether the flow direction would tend to distance them or bring them nearer to the electrode. Experiments showed that flow induced by electro-convective effects is only significant in the higher conductivity solutions that were tested and only at high frequencies, suggesting that these are electrothermal in nature. However, the introduction of tracer particles showed that except for a few specific locations, the induced flow was parallel to the electrodes and thus perpendicular to the direction of the DEP forces. Additionally, minimizing the microchannel height to 20 μm drastically suppressed these effects.

In accordance with some applications of the present invention, testing began with frequencies where the heads or tails of all the sperm cells responded positively. Subsequently, the frequency was gradually lowered until no more pDEP was observed, or until the response was not exclusively positive, with some cells undergoing pDEP and others nDEP (due to the inherent biological variability of the cells). This point was then designated as the upper boundary of the region. The same process was done for the lower boundaries with nDEP. Error bars were also designated up until the point where very clear exclusive positive or negative behavior was observed.

FIG. 1A shows the quadrupolar electrode setup used for determining the cell COF. FIG. 1A shows a specific image showing the response for conditions of frequency 1 MHz and medium conductivity of 110 mS/m. Sperm A's head is being repelled (nDEP) by the high field gradients near the quadrupolar electrode. Sperm B is completely dead and undergoes nDEP. Sperm C's tail is undergoing pDEP and is being pulled towards the electrode. Sperm D is trying to swim past the electrode although it is unable to as its head is undergoing nDEP; (B and C) At a medium conductivity of 110 mS/m there is competition between pDEP response of the tail and nDEP response of the head.

FIG. 1B shows the response for conditions at 1500 KHz, being a pDEP response of the tail and weak DEP response of the head (close to COF). FIG. 1C shows the response for conditions at ˜300 KHz being a pDEP response of the tail and strong nDEP response of the head.

### Example 2: Geometrical Parameters

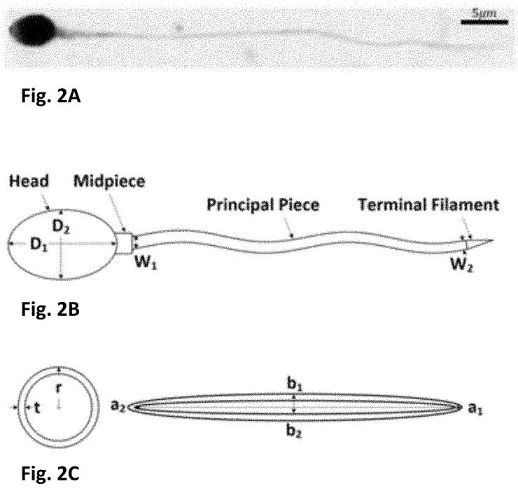

Reference is now made to FIGS. 2A-C which are a microscopic image (2A) and schematic model of sperm cells (2B-C) depicting geometrical parameters of the sperm cell.

FIG. 2A shows a microscopic image of a stained sperm cell; FIG. 2B is a schematic illustration of the outer sperm cell structure (length of tail portions not to scale); and FIG. 2C is a simplified model of the sperm head as a single shell sphere and the sperm tail as a single shell ellipsoid (not to scale).

As shown, the head is somewhat ellipsoid in shape with a diameter of 3.37 μm and a length of 5.26 μm (FIGS. 2A-B), as measured in wet specimens. The sperm head was modelled as a sphere of equivalent volume with an outer diameter of 3.91 μm (FIG. 2C). The tail consists of three portions (FIG. 2C), the midpiece is around 5 μm long, the principle piece is around 45 μm long and the terminal filament is around 5 μm long. Since each of these components has a different structure, the focus was on the principle piece as it is an order of magnitude larger than the other components. The tail diameter, as measured in fixed and stained specimens, starts at 0.88 μm in the midpiece. It then drops to 0.53 μm (W1) at the start of the principal piece, gradually tapering to 0.39 μm (W2) at its end, and drastically decreases to 0.17 μm in the terminal filament (FIG. 2B). The dimensions of the sperm shrink when fixed and are 15% larger when measured under normal wet conditions, therefore in the model the diameter was increased by 15% and modelled as an ellipsoid of equivalent volume, (as it the closest shape with an analytical solution and gives a reasonable approximation for cylindrical particles), with outer diameters of 0.65 μm and 45 μm respectively. The mathematical model used is detailed below:

The time-averaged translational DEP force on a uniform sphere in a non-uniform electric field, is

<F_{DEP}>=πR³∈ₘRe(K*(ω))∇|E|²,

where R is outer radius of the sphere, ∈ₘ is the permittivity of the media, Re (K*) is the real part of the Clausius Mossotti factor (CM), and E is the amplitude of the electric field. The CM is a complex term that is dependent on the dielectric properties of the cell and the medium and is a function of the frequency (ω) of the applied electric field that determines the direction of the DEP force. A negative CM indicates nDEP behaviour and a positive CM indicates pDEP. It is calculated as

$$K * ( ω ) = \frac{{ϵ}_{p}^{*} - {ϵ}_{m}^{*}}{{ϵ}_{p}^{*} + 2 {ϵ}_{m}^{*}} ,$$

where ∈ₚ is the permittivity of a particle (in our case the cell) and ∈* is the complex permittivity given by

$${ϵ}^{*} = ϵ + \frac{σ}{j ω} ,$$

where σ is the conductivity.

For the sperm's head, a single shell sphere model was used where eq. (3) remains the same, except for the permittivity of the cell which is obtained from the following equation]

$${ϵ}_{peff}^{*} = \frac{{ϵ}_{m e m b}^{*} [ {( \frac{r}{r - t} )}^{3} + 2 ( \frac{{ϵ}_{c y t o}^{*} - {ϵ}_{m e m b}^{*}}{{ϵ}_{c y t o}^{*} + 2 {ϵ}_{m e m b}^{*}} ) ]}{{( \frac{r}{r - t} )}^{3} - ( \frac{{ϵ}_{c y t o}^{*} - {ϵ}_{m e m b}^{*}}{{ϵ}_{c y t o}^{*} + 2 {ϵ}_{m e m b}^{*}} )} ,$$

where r is the outer radius of the cell, t is the thickness of the membrane, ∈*_{memb} is the complex permittivity of the membrane and ∈*_{cyto} is the complex permittivity of the cytoplasm.

For the sperm's tail, a single shell ellipsoid model was used where the CM is calculated as follows

$$K * ( ω ) = \frac{{ϵ}_{p}^{*} - {ϵ}_{m}^{*}}{3 ( {ϵ}_{p}^{*} - {ϵ}_{m}^{*} ) {A}_{1} + {ϵ}_{m}^{*}} ,$$

where A1 is the depolarization factor along the polarized axis for the outermost shell. For the case of a prolate ellipsoid where the radius along the three axes is given by a>b=c, the depolarization factor along a is given by [ ]

$${A}_{k} = \frac{1 - {e}_{k}^{2}}{2 {e}_{k}^{3}} ( ln ( \frac{1 + {e}_{k}}{1 - {e}_{k}} ) - 2 {e}_{k} ) ,$$

where the subscript k denotes the shell number (i.e. k=2 for the cytoplasm and k=1 for the membrane) and e is the eccentricity given by [

$${e}_{k} = \frac{\sqrt{{a}_{k}^{2} - {b}_{k}^{2}}}{{a}_{k}} ,$$

where a and b are the radii of the large and small axes respectively.

The effective permittivity ∈*_{peff} is given by]

$${ϵ}_{peff}^{*} = {ϵ}_{m e m b}^{*} [ \frac{{ϵ}_{m e m b}^{*} + ( {ϵ}_{c y t o}^{*} - {ϵ}_{m e m b}^{*} ) ( {A}_{2} + v ( 1 - {A}_{1} ) )}{{ϵ}_{m e m b}^{*} + ( {ϵ}_{c y t o}^{*} - {ϵ}_{m e m b}^{*} ) ( {A}_{2} - v {A}_{1} )} ] ,$$

where A is the depolarization factor and v is the volume ratio given by]

$$v = \frac{{( {b}_{2} )}^{2} ( {a}_{2} )}{{b}_{1}^{2} {A}_{1}} .$$

### Example 3: Unique COFs of the Head and Tail of Sperm

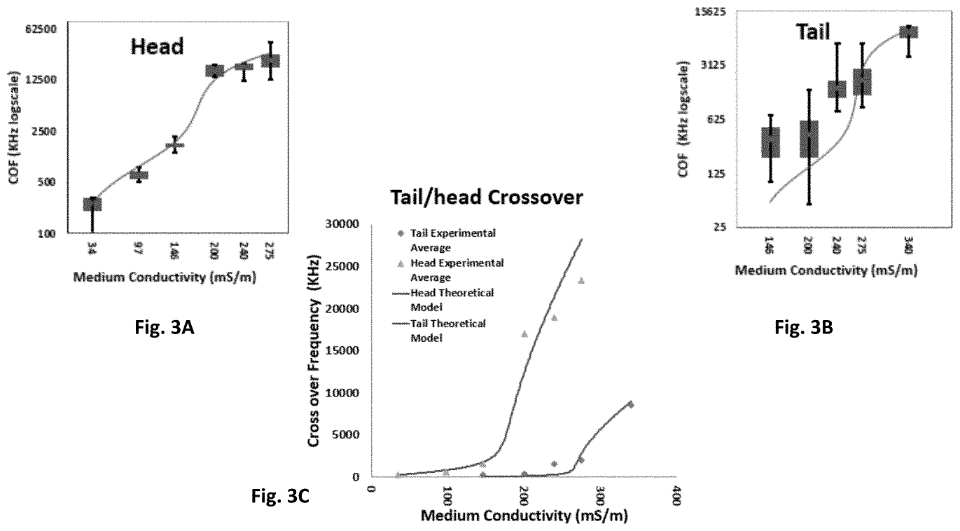

Reference is made to FIGS. 3A-C which are graphs depicting the measured and theoretically fitted COF results for both the head and tail, in accordance with some applications of the present invention.

The head and tail of the sperm exhibited independent DEP responses with each having its own COF. FIGS. 3A-C depict the measured and theoretically fitted COF results for both the head and tail. In the low frequency range, both the head and tail had a negative response. In the middle range, the tail responded positively, while the head still displayed negative behaviour and in the high frequency range, both the head and the tail were positive.

FIGS. 3A-C show the COF region (with error bars) versus solution conductivities of the: head (FIG. 3A); and tail (FIG. 3B). Both the head and tail are plotted in part (FIG. 3C). Experimental results, calculated as the center of the crossover region, are plotted as symbols. In all three graphs the theoretical best fit models are plotted as continuous lines. Best fit parameters for the head are

$${ϵ}_{m e m b} = 14 , {σ}_{m e m b} = 0.1 \frac{μ S}{m} , {ϵ}_{c y t o} = 180 , {σ}_{c y t o} = 190 \frac{m S}{m}$$

and for the tail are

$${ϵ}_{m e m b} = 2.5 , {σ}_{m e m b} = 10 \frac{μ S}{m} , {ϵ}_{c y t o} = 196 , {σ}_{c y t o} = 790 \frac{m S}{m} .$$

### Example 4: Dielectric Properties of the Head and Tail of Sperm

Matlab was used to compare many combinations of the electrical parameters of the sperm that would best fit the data obtained in accordance with application of the present invention. A spherical single shell model was used for the head and an ellipsoidal single shell model was used for the tail (as shown in FIG. 2C). Due to the non-uniqueness of a set of values for the fitting parameters (as different combinations can yield similar error relative to the experimental data), instead ranges were examined of the fitted parameters from which different combinations of the parameters (within these indicated ranges) can be found that result in similar error values in relation to the experimental data. Table 1 shows ranges that can yield combinations with less than a 10% error from the crossover region (best fit is 2.3%) for the head and 40% (best fit is 31.4%) for the tail. For illustration, the best fit curves are plotted in FIGS. 3A-C.

Although sperm cells are very different from other cell types, both in shape and composition, for reference and comparison, values found in other studies for various cell types, for example leukocytes, are also listed in Table 1. As can be seen, the values obtained in this study are similar to those obtained for other cell types, aside for the value for the cytoplasm conductivity in the head of the sperm, which is significantly lower. This can possibly be attributed to the high density of DNA found in the sperm head relative to other cell types. During spermiogenesis, the process whereby round spermatid cells mature into sperm, nearly all of the cytoplasm is removed from the cell with nearly 90% of the cytoplasm eliminated in the late stages. This results in a sperm head where the vast majority of its volume is comprised of a small, highly condensed nucleus. Although DNA is highly charged, in sperm, it is bound to protamine, a positively charged protein, that completely neutralizes the charge. When analyzed using DEP, DNA shows a relatively low conductivity of 10 mS/m.

To model the behavior of the tail, a fixed cytoplasm conductivity was not used, as the obtained models did not match the experimental data. Therefore a model was used that also accounts for how the medium's conductivity affects the cytoplasm's conductivity. A parameter β was defined for the weight of the medium conductivity versus the weight of the original internal conductivity.

σ_(internal-effective)=βσ_medium+(1−β)σ_(internal-original) (1)

In the model, β was found to be 0.97. This value presumes that the interior conductivity is highly dependent on the external medium conductivity. A similar yet other model with a similar weight for the external conductivity was used by for the DEP of electroporated cells where there is a high level of ion exchange between the cytoplasm and the surrounding medium. In this case, the high value for β in the tail, and its absence in the head, points to a very high level of ion exchange in the tail with minimal ion exchange in the sperm head. This can possibly be explained by the presence of a large number of voltage gated ion channels in the principle piece of the tail that are not present in the head of the sperm. These channels allow for the rapid transport of ions out of the cell in response to transmembrane potentials. In some cases, in response to a transmembrane potential the current of k+ ions out of the sperm is 40 times higher in the tail than in the head. Due to the very small amount of cytoplasm in the sperm, even a minute amount of ion exchange can have a significant impact. The depletion of ions in the tail's cytoplasm however, is hypothesized by the inventors not affect the head, as the open connection between them is relatively miniscule, limiting diffusion and effectively compartmentalizing them.

TABLE 1

| | | | Value ranges for other |
|---|---|---|---|
| Parameter | Head | Tail | cell types |
| Membrane conductivity | 0.1-50 | 0.11-15 | 0.1 |
| (μS/m) | | | 7.7-85 |
| Membrane relative | 12-14 | 2.5-6 | 2.5-5 |
| permittivity | | | 5 |
| | | | 6.5 14 |
| Cytoplasm conductivity | 180-210 | 430-880 | 460 910 500 |
| (mS/m) | | | 340 1400 |
| Cytoplasm relative | 125-195 | 122-196 | 80 |
| Permittivity | | | 80-194 |
| β | 0-0.4 | 0.90-0.97 | |

With reference to Table 1, the first two columns of Table 1 provide ranges for the dielectric properties of the sperm cells as determined by the theoretical models created in accordance with applications of the present invention. The third column presents, for comparison, ranges for these parameters in other biological cell types.

### Example 5: Sorting Strategy Based on the Distinct Head and Tail DEP Responses

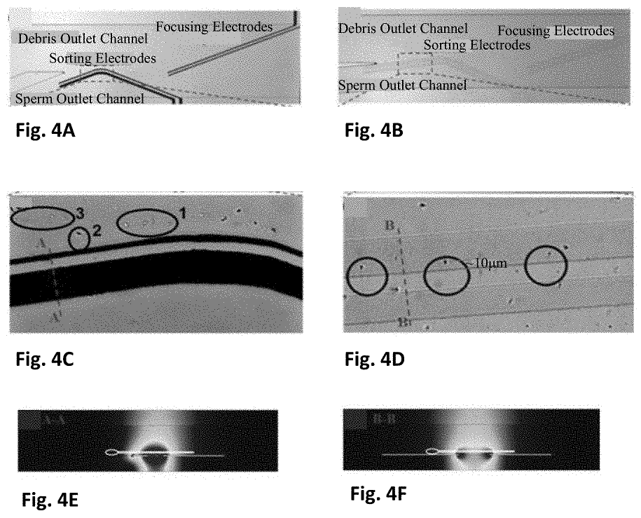

Reference is made to FIGS. 4A-F which are images of apparatus comprising a sorting chip for trapping and isolating sperm cells from other debris in a mixture, in accordance with some applications of the present invention. In particular, FIGS. 4A-F show experiments using the apparatus comprising the sorting chip, in accordance with some applications of the present invention.

The independent behavior of the tail and head allows for the use of pDEP to trap and isolate sperm cells from the other debris in the mixture, which in the experiments conducted in accordance with applications of the present invention, generally exhibited nDEP behavior. Simultaneously, the head of the sperm cell is distanced from the potentially harmful high electric field by its nDEP response. To test this, in accordance with applications of the present invention, chips were designed with a curved electrode pair (FIGS. 4A-B). The sperm cell's tail is attracted to the electrode while the head is repelled. This generally resulted in the sperm aligning itself perpendicularly to the electrodes, with its tail attracted to the edge of the electrodes and its head distanced from the electrodes edge (FIGS. 4C-D), where the field gradients are highest (FIGS. 4E-F). In the design with ITO electrodes, the head is kept on top of a wide electrode (FIG. 4D) where the field is relatively low (FIG. 4F), while in the narrow gold electrode design, the head is distanced from the electrodes entirely (FIGS. 4C and E). The sperm cells generally flow downstream along the electrode in the perpendicular alignment until reaching the sperm outlet channel.

The alignment of the sperm perpendicular to the electrode (and therefore by design, perpendicular to the flow), means that the flow induces a drag force along the sperm's length. The DEP force however, acts along the axis of the sperm, perpendicular to the drag, pulling the end of the tail towards the electrodes. The nDEP of the head keeps the sperm from getting anchored at both ends to the electrodes. This helps prevent the electrodes from trapping the sperm, as opposed to frequencies where both the head and tail are positive and the sperm, as in conventional pDEP, get stuck in place. The trapped sperm can therefore be moved by the flow along the sorting electrodes and guided by the DEP force towards an alternate sperm outlet channel at the side of the main channel (FIGS. 4A-B and sperm (1 an d2) in FIG. 4C). The debris in the sample undergoes nDEP and is repelled by the electrodes. It is guided towards the center of the channel where it follows the flow to the main debris outlet channel (FIGS. 4A-B and debris (3) in FIG. 4C). Dead sperm also generally undergo nDEP and are also directed to the main outlet. Rarely, the tails of sperm whose heads were stained by the PI (meaning that their membrane was not intact) still had a positive response. The inventors hypothesize that a possible explanation is that although the head's membrane had degraded, the tail's membrane had not yet fully degraded, and since the cytoplasm of the head and tail is compartmentalized, the tail maintained its pDEP.

Depending on the design, the electric fields experienced by the head are one to two orders of magnitude lower than if pDEP was used to attract the head (FIGS. 4E-F). This enables the safe use of pDEP for sorting sperm from debris, which generally exhibits a negative DEP (nDEP) response.

Reference is still made to FIGS. 4A-F. Potential sorting via a curved electrode pair based on the tail/head and live/dead distinction is demonstrated for the sorting chip fabricated in accordance with some applications of the present invention. FIGS. 4A and B show the sorting chip design consisting of two curved (FIG. 4A) Au/Cr electrodes with widths of 10 μm and 40 μm respectively spaced 10 μm apart and (FIG. 4B) ITO electrodes with widths of 50 μm and 40 μm respectively spaced 20 μm apart; The focusing electrodes are kept at a frequency that induces nDEP for both the head and tail, while the sorting electrode is held at a frequency that induces nDEP for the head but pDEP for the tail; (FIG. 4C) Live sperm cells (1 and 2) are following the electrode with their tail, perpendicular to and above the electrodes, undergoing pDEP in the gap between the electrodes. Their heads are at a distance of 10 to 20 μm from its edge where the electric field is respectively one and two orders of magnitude lower than at the electrodes edge (FIG. 4E), while the debris (3) continues onwards following the fluid flow. FIG. 4D shows three live sperm cells being diverted from the horizontal streamlines and following the ITO electrodes to an alternate exit port. Their tails, perpendicular to and above the electrodes, are undergoing pDEP in the gap between the electrodes. Their heads are directly above the electrode and are distanced roughly 10 μm from its edge where the electric fields are one fifth as strong than at the edge (FIG. 4F). FIGS. 4E and F depicts COMSOL simulations of the electric field in the corresponding cross-sectional geometry of the electrode setup in FIGS. C-D respectively. A DC voltage difference of 10V was applied between the electrodes. The color scale plotted corresponds to an electric field intensity from 10 KV/m (dark blue) up to 700 KV/m (dark red).

Reference is now made to FIGS. 1A-5B. As shown herein in accordance with some applications of the present invention, the head and tail of a sperm cell have unique and independent electrical characteristics. Whereas in the low and high frequency ranges, both the head and tail had negative and positive responses respectively, in the middle range, the tail responded positively, while the head still displayed negative behavior. Accordingly, this led to different dielectric properties of the sperm head and tail as indicated in Table 1. Additionally, the behavior of the tail required a model that accounts for the substantial effect of the medium conductivity on the tail's cytoplasm conductivity.

In accordance with some applications of the present invention, the methods and apparatus disclosed herein can use the DEP effect to manipulate the sperm by their tail while simultaneously distancing the head from regions with high electric fields, leading to an effective and safe automated method for the high throughput isolation of rare sperm. As demonstrated herein using the sorting chip apparatus in which the sperm cell, trapped by its tail on the electrodes, was diverted to a side channel using curved electrodes. The low crossover frequency of the tail also enables, in accordance with applications of the present invention, the use of higher conductivity solutions that are more physiological than those conventionally used in DEP. Additionally or alternatively, raw semen diluted to a lower conductivity could be sorted directly, eliminating the harmful centrifugation often used in concentrating sperm.

Reference is still made to FIGS. 1A-5B. it is noted that the description and figures herein describe use of fixed metal electrodes by way of illustration and not limitation. It is noted that for some the dielectrophoresis (DEP) is light induced by providing apparatus having a glass surface having photosensitive area that become conductive in response to light, thereby functioning as dynamic electrodes that are not fixed and change locations based on light. In accordance with some applications of the present invention, these electrodes can be used in combination with method and apparatus described herein for manipulating and trapping a sperm cell.

Reference is still made to FIGS. 1A-5B. in cases in which no sperm can be found in the ejaculate, testicular sperm is used in accordance with apparatus and methods described herein. In such cases either a biopsy of testis is taken, or testicular tissue is removed surgically. The testicular tissue is typically disassociated, and sperm is sorted using apparatus and methods described herein. In particular, use of the apparatus and methods described herein allow sorting a minute number the sperm cells out of a mixture of many other cell types in present in the testis, such as sertoli cells and blood cells. Additionally, or alternatively, use of the apparatus and methods described herein allow for capturing immotile sperm cells as well as sperm cells at various stages of development including elongated spermatids and round spermatids which are fertile.

It is noted that although results herein are shown for sperm cells, it is noted that the scope of the present invention includes manipulating other hybrid DEP particles (i.e. consisting of multiple parts that exhibit distinct DEP responses) with numerous control parameters and tuneable complex behaviors.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A viable sperm cell manipulation apparatus comprising:
a fluid chamber for receiving a biological sample, the biological sample comprising at least one viable sperm cell having a tail and a head;
at least one electrode coupled to the chamber and in operable communication with an electric source configured to apply alternating current (AC) field frequencies to drive the at least one electrode to generate a dielectrophoresis (DEP) force in the chamber;
wherein, in operation, in response to the DEP force: (i) the tail of the at least one viable sperm cell is attracted to the electrode and brought into proximity to the electrode, and simultaneously (ii) the head is repelled and distanced from the electrode such that a proximity of the tail to an edge of the electrode is greater than a proximity of the head to the edge of the electrode, and
wherein the viable sperm cell comprises a sperm cell selected from the group consisting of: a live motile sperm cell, a live immotile sperm cell, an immature germ cell.

2. The apparatus according to claim 1, wherein the at least one electrode is configured to generate the DEP by operating at a frequency in which the tail exhibits a positive DEP response and the head exhibits a negative DEP response.

3. The apparatus according to claim 1, wherein the at least one electrode is configured to generate the DEP by operating at a frequency that is above a crossover frequency (COF) of the tail and below a COF of the head, a crossover frequency being a frequency at which transition occurs between a negative DEP response and a positive DEP response.

4. The apparatus according to claim 1, wherein the at least one electrode is configured to operate at a frequency of 10 kHz-100 MHz.

5. The apparatus according to claim 1, wherein the fluid chamber comprises a sorting medium having a conductivity of 5-500 mS/m.

6-7. (canceled)

8. The apparatus according to claim 5, wherein the at least one electrode is configured to generate the DEP by operating at a frequency of 50 KHz-40 MHz when the fluid has a conductivity of 200-350 mS/m.

9. The apparatus according to claim 1, wherein the at least one electrode comprises a pair of sorting electrodes.

10. The apparatus according to claim 9, wherein the pair of sorting electrodes has an intra-electrode distance of 1-50 microns.

11. The apparatus according to claim 9, wherein each of the electrodes are shaped to define a curved electrode.

12. The apparatus according to claim 1, wherein the at least one electrode comprises a sorting electrode, and wherein the apparatus further comprises at least one focusing electrode upstream from the sorting electrode and configured to operate at a frequency in which the head, the tail and other components in the biological sample exhibit a negative DEP response, to guide the biological sample towards the sorting electrode by repelling the biological sample from the focusing electrode.

13. The apparatus according to claim 12, where the at least one focusing electrode is configured to operate below a crossover frequency (COF) of the head, the tail and other components in the biological sample.

14. The apparatus according to claim 12, wherein the fluid chamber comprises a sorting medium having a conductivity of 5-500 mS/m, and wherein the fluid chamber further comprises a high conductivity medium having a conductivity of 800-1600 mS/m, upstream from the sorting electrodes, and
wherein the at least one focusing electrode is configured to operate in the high conductivity medium to guide the biological sample towards the sorting medium.

15. The apparatus according to claim 12:
wherein the at least one focusing electrode comprises a first focusing electrode and wherein the apparatus further comprises a second focusing electrode downstream from the sorting electrodes and
wherein, the fluid chamber further comprises a high conductivity medium having a conductivity of 800-1600 mS/m, downstream from the sorting electrodes, and
wherein the second focusing electrode is configured to guide the at least one viable sperm cell from the sorting electrode to the high conductivity medium downstream from the sorting electrodes.

16. The apparatus according to claim 12, wherein the at least one focusing electrode comprises a pair of focusing electrodes.

17. The apparatus according to claim 1, wherein the fluid chamber is shaped to define (i) a main flow channel in communication with the at least one electrode, (ii) a debris outlet channel downstream from the at least one electrode, and (iii) a sperm outlet channel downstream from the at least one electrode, and wherein in response to the DEP force the at least one viable sperm cell is guided into the sperm outlet channel and the components in the biological sample that are not the at least one viable sperm cell are guide into the debris outlet channel.

18. The apparatus according to claim 1, further comprising a flow inducer configured to induce flow of the biological sample in the fluid chamber past the at least one electrode.

19-21. (canceled)

22. The apparatus according to claim 12, wherein in response to the DEP force at least some of the other components in the biological sample are repelled and distanced from the at least one electrode.

23.-24. (canceled)

25. Apparatus for use with a biological sample, the biological sample including at least one viable sperm cell having a tail and a head, the apparatus comprising:
a main flow channel (i) shaped to define an inlet for introducing the biological sample into the main flow channel and (ii) shaped and sized for flow of the biological sample through the main flow channel;
a pair of sorting electrodes electrically coupled to the main flow channel downstream from the inlet;
a sperm outlet channel downstream from the pair of sorting electrodes;
a debris outlet channel downstream from the pair of sorting electrodes;
wherein the pair of sorting electrodes are in operable communication with an electric source configured to apply alternating current (AC) field frequencies by driving the pair of sorting electrodes to generate a dielectrophoresis (DEP) force in the main flow channel, such that, in operation, in response to the DEP force:
(a) components in the biological sample that are not the at least one viable sperm cell are repelled from the pair of sorting electrodes and guided into the debris outlet channel;
(b) the tail is attracted to and brought into proximity with the pair of sorting electrodes, and simultaneously, the head is repelled and distanced from electrodes, and
(c) the viable sperm cell is guided into the sperm outlet channel.

26.-46. (canceled)

47. A method comprising:
using a biological sample including at least one viable sperm cell having a tail and a head;
subjecting the biological sample to a dielectrophoresis (DEP) force by applying alternating current (AC) field frequencies to the biological sample by driving at least one electrode;
in response to the dielectrophoresis (DEP) force, simultaneously eliciting a positive DEP response in the tail and a negative DEP response in the head thereby preventing damage to the head by orienting the sperm such that a proximity of the tail to an edge of the electrode is greater than a proximity of the head to the edge of the electrode; and
isolating the sperm cell from the biological sample.

48. (canceled)

49. The method according to claim 47, wherein the at least one electrode is configured to generate the DEP by operating at a frequency that is above a crossover frequency (COF) of the tail and below a COF of the head, a crossover frequency being a frequency at which transition occurs between a negative DEP response and a positive DEP response.

50.-61. (canceled)
